(19) United States
(12) Patent Application Publication
(10) Pub. No.: US 2008/0098981 A1
(43) Pub. Date: May 1, 2008

(54) FLUID PASSAGE ORIFICE RING AND METHOD

(75) Inventors: Edgardo Y. Estacio, Itasca, IL (US); Roman V. Goluch, Chicago, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/554,995

(22) Filed: Oct. 31, 2006

(51) Int. Cl. F02B 77/00

(52) U.S. Cl. 123/198 R

(57) ABSTRACT

An orifice ring (316) arranged to be press-fit into a passage (308) includes an orifice face (318) having an opening (320) formed therein, a retention portion (326) having an edge (402) disposed opposite the orifice face (318), and a curved portion (404) disposed between the orifice face (318) and the retention portion (326). The retention portion (326) is oriented such that the edge (402) lies further outward than the orifice face (318). The retention portion (326) is arranged to elastically deflect inward toward the orifice face (318) when the orifice ring (316) is disposed in a passage (308).

### FIELD OF THE INVENTION

This invention relates to internal combustion engines, including but not limited to fluid passages in a crankcase of an internal combustion engine.

### BACKGROUND OF THE INVENTION

Internal combustion engines include crankcases having a plurality of cylinders and fluid passages formed therein. Some of the fluid passages in engine crankcases are constructed to transfer engine fluids, such as fuel, oil, coolant and so forth, from one location of the engine, typically a reservoir or a pump, to another, typically an engine component requiring such fluids for operation. In a typical engine, these fluid passages may form distribution networks for distributing fluids from a central location to a plurality of other locations on the engine.

A typical engine configuration may include two types of fluid circuits; open ended circuits may be arranged to transfer fluid therethrough an supply components that use the fluid supplied to them for operation, for example fuel being supplied to fuel injectors, or closed loop systems that are arranged to circulate fluid to and from one general location, for example circulation of coolant to cool the engine being circulated to and from a coolant pump. Either type of coolant circuit may require a balancing of one or more flow circuits to ensure proper operation.

Balancing of flow circuits in engines is typically accomplished by the addition of flow orifices at certain locations along one or more fluid paths that make up each circuit. These flow orifices are usually openings formed in various components having a closely controlled size that introduce a known pressure drop in a fluid circuit. One known method of providing flow orifices for fluid passages in engines may be seen in the following references.

U.S. Pat. No. 4,633,911 by Lohn, published on Jan. 6, 1987, discloses an orifice seal that is adapted to be inserted into an orifice meter tube for determining fluid velocity within the tube. This seal comprises a flat disk having an opening (the flow orifice) and a seal arrangement disposed along an outer periphery of the disk that includes a spring loading mechanism.

U.S. Pat. No. 4,653,761 by Baugh et al., published on Mar. 31, 1987, discloses a head gasket for an engine having a plurality of apertures that are relatively small in comparison to the circular cut-outs that correspond in number and position to coolant passages formed in the faces of the cylinder block and cylinder heads of the engine. The smaller-sized apertures, in this seal configuration, act as orifices to a flow of coolant passing therethrough.

The known methods described above may be modified to yield other combinations, some are relatively simple to implement, but most may not be suitable for all applications. For example, a fluid passage carrying coolant at relatively high flow rates may require a simpler and more cost effective orifice configuration that the one described in the Lohn reference, and the configuration proposed by Baugh may be inoperable due to the small thickness of the gasket material. Plates having orifice openings that are made of a flexible material are known to cause fatigue in the material around the rim of the orifice opening due to a potential resonance condition under high flow conditions, or even cause a section of the material around the orifice to shear.

Accordingly, there is a need for an improved fluid passage orifice configuration for transferring fluid in an engine under high flow rates that is simple, robust, cost effective, and that does not include an opening in a material having a thin cross-section, such as a gasket substrate material.

### SUMMARY OF THE INVENTION

An orifice ring arranged to be press-fit into a passage includes an orifice face having an opening formed therein, a retention portion having an edge disposed opposite the orifice face, and a curved portion disposed between the orifice face and the retention portion. The retention portion is oriented such that the edge lays further outward than the orifice face, in a radial direction. The retention portion is arranged to elastically deflect inward toward the orifice face when the orifice ring is disposed in a passage.

An internal combustion engine that includes a fluid pump in fluid communication with a fluid distribution circuit and at least one engine component arranged and constructed to receive a flow of fluid from the fluid pump through the fluid distribution circuit, may include a ring in a fluid passage that is part of the fluid distribution circuit. The ring may include an orifice face having an opening, and a retention portion disposed peripherally around the orifice face such that the opening is arranged and constructed to constrict the flow of fluid in the fluid passage, and the retention portion of the ring is arranged to interfere with an inner surface of the passage to retain the ring in place.

A method for providing an orifice in a passage includes the step of locating an orifice ring adjacent to an opening of the passage. The orifice ring is pressed with a plug into the passage through the opening, and a retention portion of the orifice ring is elastically deformed. A retention force is provided between the retention portion of the orifice ring and an inner surface of the passage. The plug is removed from the passage and the orifice ring is left in place such that an orifice opening formed in the ring is disposed in the passage.

### BRIEF DESCRIPTION OF THE DRAWINGS

FIG. 1 is a block diagram of an engine having a fluid pump connected to distribution circuits that are arranged to provide engine component(s) with a flow of fluid in accordance with the invention.

FIG. 2 is a cross section view of a known orifice configuration for a fluid passage.

FIG. 3 is a cross section of a fluid passage having an orifice ring placed therein in accordance with the invention.

FIG. 4 is an isometric view of an orifice ring in accordance with the invention.

FIG. 5 is a cross section view of the orifice ring of FIG. 4.

FIG. 6 is a cross section view of an installation configuration of an orifice ring by use of a plug, in accordance with the invention.

FIG. 7 is a flowchart for a method of providing an orifice in a fluid passage in accordance with the invention.

### DESCRIPTION OF A PREFERRED EMBODIMENT

An improved fluid passage orifice configuration for transferring fluid in an engine under high flow rates is simple, robust, cost effective, and does not include an opening in a material having a thin cross-section making it prone to shearing failures, such as an opening in a gasket substrate material.

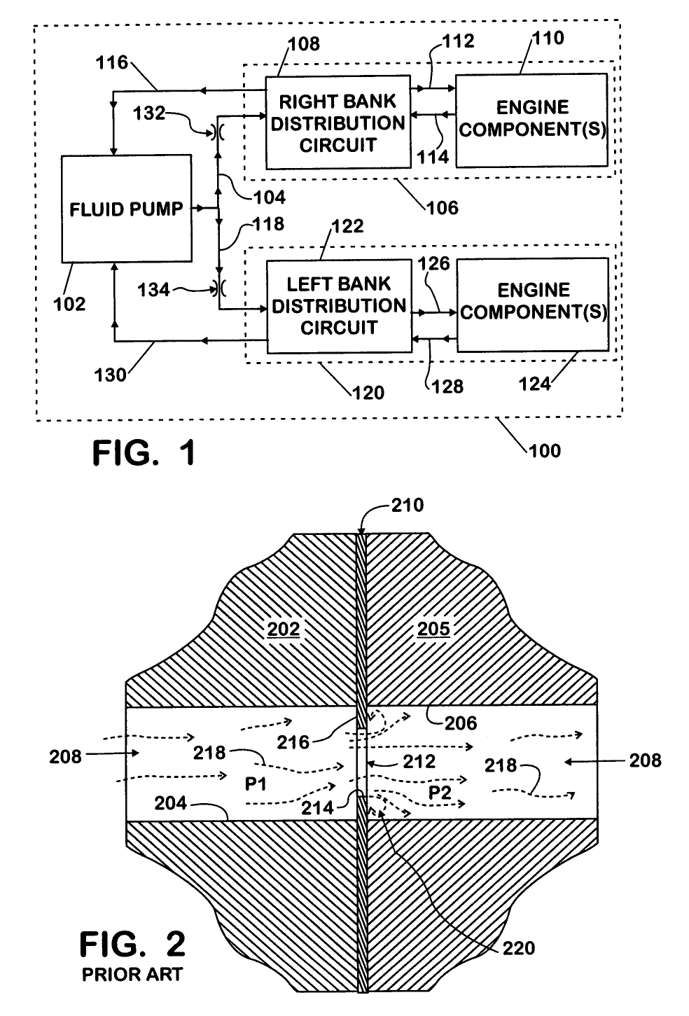

The following describes an apparatus for and method of restricting a fluid flow within a passage using a press-in-place orifice ring. A block diagram of a fluid distribution circuit for an internal combustion engine 100 is shown in FIG. 1. The engine 100 may include a fluid pump 102 that is arranged to pump a fluid throughout the engine, such as, fuel, engine oil, coolant, and so forth. The engine 100 is shown for example, and may have a “V” configuration, i.e. two banks of cylinders that are each arranged in a row. The fluid pump 102 may be arranged to have two fluid supplies, one for each bank. A first supply passage 104 may supply fluid to a first or a right hand bank (RB) 106 that may include a single passage or, in general, a network of passages that form a RB distribution circuit 108 that distributes fluid from the passage 104 to one or more engine component(s) 110. Each of the engine components 110 may have a supply line 112, and a return line 114, each connected to the RB distribution circuit 108. A RB return passage 116 may connect the RB distribution circuit 108 with a collection reservoir (not shown) of the engine, or an inlet of the fluid pump 102, depending on the configuration of the engine and the fluid used.

Similarly, the engine 100 may include a second supply passage 118 to supply fluid to a second or a left hand bank (LB) 120 that may include a single passage or, in general, a network of passages that form a LB distribution circuit 122 that distributes fluid from the passage 118 to one or more engine component(s) 124. Each of the engine components 124 may have a supply line 126, and a return line 128, each connected to the LB distribution circuit 122. A LB return passage 130 may connect the LB distribution circuit 122 with the fluid pump 102.

Oftentimes, packaging considerations and individual component fluid requirements cause fluid circuits in different areas of an engine to have different fluid circuit characteristics. In the example shown, the RB distribution circuit 108 may have different flow characteristics than the LB distribution circuit 122. In order to ensure an adequate and uniform flow of fluid to the engine component(s) 110 and 124, the fluid system driven by the pump 102 may require “balancing”. Balancing is typically accomplished by the addition of known pressure regulating devices, or orifices, in the system at various locations to ensure that any imbalances are removed from the fluid system.

A first flow orifice 132 may be added to the passage 104 between the fluid pump 102 and the RB distribution circuit. Similarly, a second flow orifice 134 may be added to the passage 118 between the pump 102 and the LB distribution circuit. Each of the first and second orifices may advantageously have different flow characteristics, and their combined effect may balance the flow of fluid exiting the pump 102 during operation and ensure that an equal mass flow rate of fluid reaches the engine component(s) 110 and 124.

A known configuration for introducing a flow orifice in a fluid passage at an interface between adjacent engine components is shown in FIG. 2 in a cross sectional view. A first engine component 202 having a first passage 204 formed therein may be connected to a second component 205 that has a second passage 206 formed therein that aligns with the first passage 204 to form a fluid passage 208 therethrough. A gasket 210 having an opening 212 may be disposed between the components 202 and 205. The opening 212 may be arranged to lie within the passage 208. An inner diameter of each of the passages 204 and 206 may be larger than an equivalent flow diameter required by the passage 208 to balance a fluid system. For this reason, the opening 212 in the gasket 210 may have an inner diameter 214 that is smaller than the inner diameters of the passages 204 and 206 and be appropriately sized to make the opening 212 in the gasket 210 act as a flow orifice for the passage 208. A section of the gasket 216 that lies between the smaller diameter 214 and the inner diameter of the passages 204 and 206 may be made of the same base material of the gasket 210, and effectively provide a restriction to a flow passing through the passage 208 in the two components 202 and 205 during operation.

When a flow of fluid 218 passes through the passage 208, the flow of fluid 218 denoted by dotted arrows, it may be forced to accelerate through the opening 212 when passing from the first passage 204 into the second passage 206. As the flow 218 passes through the opening or orifice 212, a first static pressure, P1, which exists in the first passage 204, may advantageously drop to a second static pressure, P2, which exists in the second passage 206. Under conditions of high flow rates of the flow 218, a low pressure region 220 may be formed as fluid swirls in an area between the orifice 212 and the larger diameter of an exit passage, in this case the second passage 206, thus creating a region where the pressure is even lower than the pressure P2. A pressure difference between the pressures P1 and P2 may act on the section 216 during operation of the passage 208, especially if the pressures P1 and P2 are fluctuating. This pressure difference may create a force acting on the section 216 in the direction of flow that acts to shear the section 216 off the gasket 210. This shearing effect can cause a failure in the gasket 210 that will not only affect a balance of the fluid system that includes the passage 208, but it can also introduce debris in the flow 218 if a sheared section of the section 216 happens to break off the gasket 210 as is often the case. This and other disadvantages may be avoided as described below.

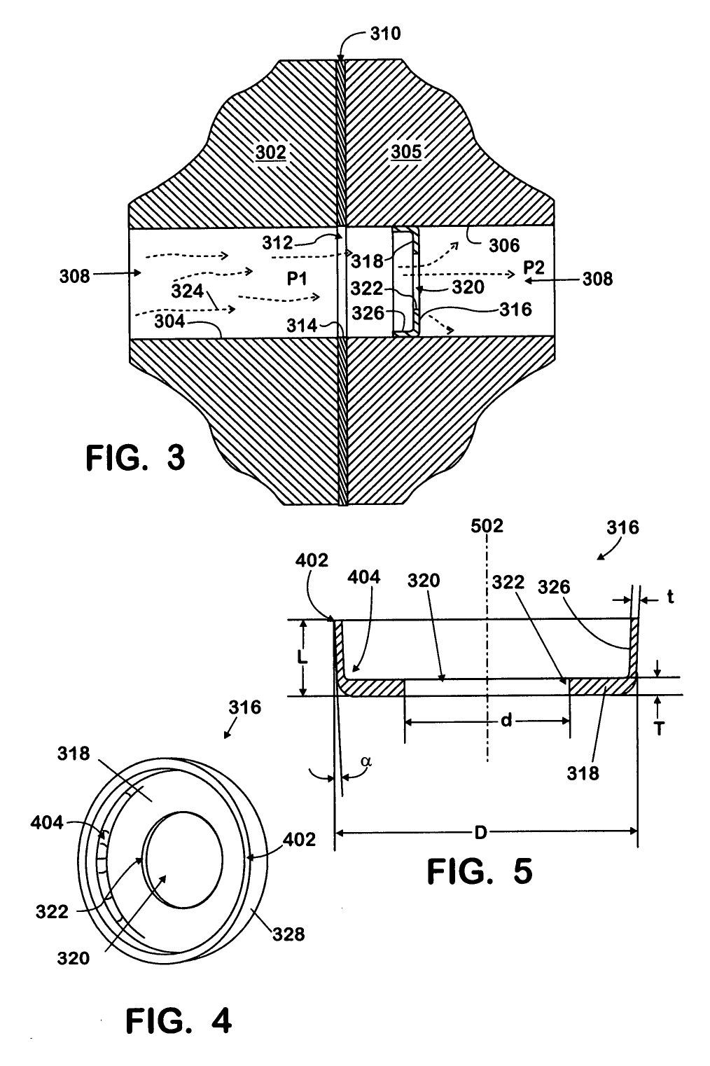

An embodiment of an improved flow orifice in a fluid passage at an interface between adjacent engine components is shown in FIG. 3 in a cross sectional view. A first engine component 302 having a first passage 304 formed therein may be connected to a second component 305 that has a second passage 306 formed therein that aligns with the first passage 304 to form a fluid passage 308 therethrough. A gasket 310 having an opening 312 may be disposed between the components 302 and 305. The opening 312 may be arranged to lie within the passage 308 and have an inner diameter 314 that is about the same as the inner diameters of the passages 304 and 306 to advantageously avoid any shearing of any portion of the gasket 310 as described above.

An orifice ring 316 may be disposed in the passage 308 to provide a desired flow restriction therethrough. The orifice ring 316 may include an orifice face 318 having an opening or orifice 320 formed therein. The opening 320 may have an inner diameter 322 that is smaller than an inner diameter of the first passage 304 and/or the second passage 306 to provide a desired pressure drop of a fluid flow 324, denoted by dashed arrows that may be passing through the passage 308 during operation. The orifice ring 316 may have a retention portion 326 that is disposed around the orifice face 318, connected thereto along a periphery thereof, and in interference contact with the second passage 306 for retention.

When the flow of fluid 324 passes through the passage 308 it may be forced to accelerate through the opening 320 when passing from the first passage 304 into a portion of the second passage 306 that lies downstream of the orifice ring 316. As the flow 324 passes through the opening or orifice 320 a first static pressure, P1, which exists upstream of the orifice ring 316, may advantageously drop to a second static pressure, P2, which exists on a downstream side of the orifice ring 316. A pressure difference between the pressures P1 and P2 may act on a section of the orifice face 318 that surrounds the opening 320. This pressure difference may create a force acting on the orifice ring 316 in the direction of flow that acts to shear the retention portion 326 along the second passage 306. This shearing effect can be counteracted by interference fit between the orifice ring 316 and the passage 306.

A perspective view of the orifice ring 316 is shown in FIG. 4. The orifice ring 316 may advantageously be shaped as a cup plug, or, a known device that is arranged to be press-fit into a passage formed in an engine component and provide a seal therefore. The orifice ring 316 may have an edge 402 at a distal or outer diameter of the retention portion 326 that lies furthest from the orifice face 318. A curved surface 404 may lie between and connect the orifice face 318 with the retention portion 326. The orifice ring 316 may advantageously be constructed from a single disk of material, for example a disk of metal sheet, that has been drawn into a cup shape that forms the orifice face 318 as a base of the cup, and the retention portion 326 as a side-wall of the cup. During the drawing operation, or in a subsequent operation, the opening 320 may be cut or punched out of the orifice face 318 along the inner diameter 322.

A side view in cross section of the orifice ring 316 is shown in FIG. 5. The orifice ring 316 may be made of a single piece of material that has been shaped by a forming, drawing, or another operation. The orifice face 318 may have a thickness, T that represents the thickness of a raw material used to form the ring 316. Material in the retention portion 326 may have a thickness, t, which is advantageously less than the thickness T of the orifice face 318. The thickness t may allow the retention portion 326 to deform elastically when the ring 316 is inserted into a fluid passage. The deflection of the retention feature 326 may be augmented and controlled further by orienting the retention portion 326 with respect to the orifice face 318 such that the edge 402 lies further outward, in a radial direction, with respect to the curved surface 404, or in general, protruding from a projected area of the orifice face 318. This projection of the edge 404 may be accomplished by introducing an angle, α, in the orientation of the retention portion 326 off a vertical orientation with respect to a plane of the orifice face 318. The angle α may advantageously be about 3 to 4 degrees, but other angles may be used.

The orifice ring 316 may have an orifice size, d, that is defined by the inner diameter 322 of the opening 320, and an outer diameter, D, that is defined by a projected diameter of the edge 402. The orifice size d may be appropriately sized to accommodate a desired pressure drop in a flow passing therethrough, while the outer diameter D may be appropriately sized to provide an interference fit with an inner opening size of a passage that the ring 316 will be installed into. A length, L, of the retention portion 326 along a centerline 502 of the ring 316 may be adjusted to provide a desired contact area between the retention portion 326 and the inner opening size of the passage that the ring 316 is installed.

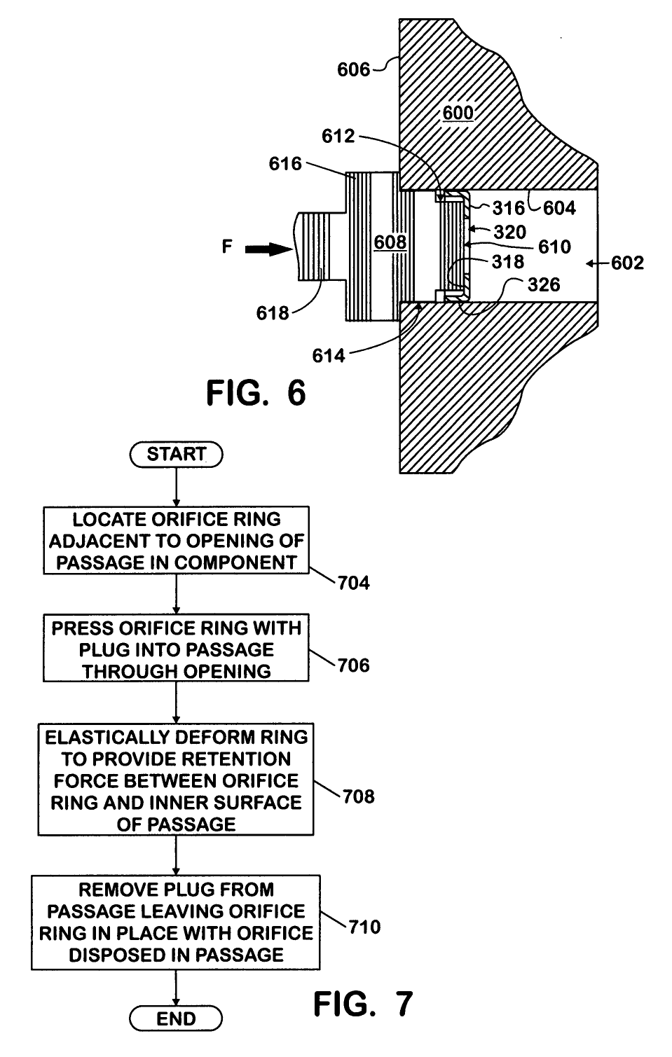

An installation configuration of the ring 316 into a component 600 is shown in cross section in FIG. 6. The component 600 may have an opening 602 that defines a passage for fluid to pass therethrough, the opening having an inside surface 604. The component 600 may have an outside surface 606 that may be substantially flat and may be interfaced with another component (not shown). A plug 608 may be used to install the ring 316 into the opening 602. The plug 608 may have a nose portion 610, a step portion 612, an alignment portion 614, a shoulder portion 616, and a shaft portion 618.

When installing the ring 316 into the component 600, the ring may be placed at an outer edge of the opening 602, and the nose 610 of the plug 608 may engage the orifice face 318. A force, F, may be applied to the shaft 618 of the plug 608 along a direction of the opening 602 to essentially push-in-place the ring 316 into the opening 602. The force F should be adequately large to cause a deformation of the retention feature 326 inwardly, caused by the inner surface 604 of the opening 602 as the ring 316 is inserted into the opening 602. The stepped portion 612 may advantageously accommodate any deformation of the retention portion 326. After the ring 316 has been inserted past an initial segment of the opening 602, the alignment portion 614 may advantageously engage the inner surface 604 of the opening 602 and help align both the plug 608 and the ring 316 with the opening 602. The shoulder 616 may touch the outer surface 606 of the component 600 and terminate an insertion of the ring 316 into the opening 602.

A flowchart for a method of introducing an orifice into a passage of a component is shown in FIG. 7. A passage may be formed in a component. The passage may be cast into the component, or alternatively machined therethrough. The passage may be a part of a fluid distribution system in, for example, and engine that includes the component. An orifice ring may be located adjacent to an opening of the passage at step 704, and may be pushed through the opening into the passage with a plug at step 706. The orifice ring may advantageously be substantially shaped as a cup-plug having an orifice formed therein. The ring may partially elastically deform at step 708 and provide a retention force between the ring and an inner surface of the passage. The plug may be removed from the passage at step 710 leaving the ring in place with the orifice formed therein disposed to provide a desired pressure drop for fluid that might flow in the component passage.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An internal combustion engine comprising:
a fluid pump in fluid communication with a fluid distribution circuit;
at least one engine component arranged and constructed to receive a flow of fluid from the fluid pump through the fluid distribution circuit;
a ring disposed in a fluid passage that is part of the fluid distribution circuit, the ring comprising
an orifice face having an opening and
a retention portion disposed peripherally around the orifice face;
wherein the opening is arranged and constructed to constrict the flow of fluid in the fluid passage, and wherein the retention portion of the ring is arranged to interfere with an inner surface of the passage.

2. The internal combustion engine of claim 1, wherein the orifice face has an outer diameter, wherein the retention portion has an edge, and wherein the edge protrudes past the outer diameter of the orifice face on an inlet side thereof.

3. The internal combustion engine of claim 1, wherein the ring is shaped from a single piece of material.

4. The internal combustion engine of claim 1, wherein the ring has an interference fit with the fluid passage, and wherein the retention portion is elastically deformed when the ring is disposed in the fluid passage.

5. The internal combustion engine of claim 1, wherein a material thickness of the orifice face is less than a material thickness of the retention portion.

6. A method for providing an orifice in a passage of a conduit comprising the steps of:
locating an orifice ring adjacent to an opening of the passage;
pressing the orifice ring with a plug into the passage through the opening;
elastically deforming a retention portion of the orifice ring;
providing a retention force between the retention portion of the orifice ring and an inner surface of the conduit;
removing the plug from the passage.

7. The method of claim 6, further comprising the step of connecting an additional component to a component, wherein the passage is formed in the component, wherein the additional component has an additional passage formed therein, and wherein the passage and the additional passage are fluidly connected when the component is connected with the additional component.

8. The method of claim 7, further comprising the step of passing a flow of fluid through the passage, the additional passage, and the orifice ring.

9. The method of claim 8, further comprising the step of creating a pressure restriction in the flow of fluid with the orifice opening.

10. The method of claim 6, further comprising the step of distributing a fluid flow through a distribution circuit in an internal combustion engine, wherein the passage is part of the distribution circuit.

11. The method of claim 10, further comprising the step of pumping the fluid flow into the distribution circuit, wherein the passage containing the orifice ring is disposed between a pump and an engine component.

12. An orifice ring comprising:
an orifice face having an opening formed therein;
a retention portion having an edge disposed opposite the orifice face;
a curved portion disposed between the orifice face and the retention portion;
wherein the retention portion is oriented such that the edge lies further outward than the orifice face, in a radial direction;
wherein the retention portion is arranged to elastically deflect inward toward the orifice face when the orifice ring is disposed in a passage.

13. The orifice ring of claim 12, wherein the orifice face, the retention portion, and the curved portion are created from a single piece of material that has been shaped by use of at least one of a forming and a drawing operation.

14. The orifice ring of claim 12, wherein the orifice face has a first thickness, wherein the retention portion has a second thickness, and wherein the second thickness is less than the first thickness.

15. The orifice ring of claim 14, wherein the second thickness is arranged and constructed to allow only the retention portion to elastically deform when the orifice ring is disposed in a passage.

16. The orifice ring of claim 12, wherein the orientation of the retention portion is accomplished by conically angling the retention portion with respect to the orifice face.

17. The orifice ring of claim 12, wherein the opening has an inner diameter, wherein the orifice face has an outer diameter, wherein the inner diameter is appropriately sized to accommodate a desired pressure drop in a flow passing therethrough, and wherein the outer diameter is appropriately sized to provide an interference fit with an inner surface of the passage.
